(19) United States
(12) Patent Application Publication
(10) Pub. No.: US 2014/0257659 A1
(43) Pub. Date: Sep. 11, 2014

(54) REAL TIME RISK ASSESSMENTS USING RISK FUNCTIONS

(71) Applicant: Honda Motor Co., Ltd., Tokyo (JP)

(72) Inventor: Behzad Dariush, San Ramon, CA (US)

(73) Assignee: Honda Motor Co., Ltd., Tokyo (JP)

(21) Appl. No.: 14/196,197

(22) Filed: Mar. 4, 2014

Related U.S. Application Data
(60) Provisional application No. 61/776,692, filed on Mar. 11, 2013.
(60) Provisional application No. 61/776,701, filed on Mar. 11, 2013.

(51) Int. Cl. G08G 1/16

(52) U.S. Cl. CPC G08G 1/166
USPC 701/70; 701/1

(57) ABSTRACT

A driver assistance system takes as input a number of different types of vehicle environment inputs including positions of hazards such as a road boundary, lane boundaries, and objects in the vehicle's environment. The driver assistance uses the inputs to determining a lane change risk function based on the lane boundary position, a road boundary risk function based on the road boundary position, and a collision risk function based on the object position. The risk functions quantifying the risk posed to the vehicle by the detected hazards. Based on the risk functions, the driver assistance controls an actuator of the vehicle. This may include control of actuators such as the steering wheel, brake system, and gas, as well as audio and visual display and warning systems.

### CROSS REFERENCE TO RELATED APPLICATIONS

This application claims the benefit of U.S. Provisional Patent Application Ser. No. 61/776,692, filed Mar. 11, 2013 and U.S. Provisional Patent Application Ser. No. 61/776,701, filed Mar. 11, 2013, the contents of which are incorporated herein by reference in their entirety.

### FIELD OF ART

This disclosure relates to driver assistance systems and more particularly to automotive driver assistance systems using risk functions.

### BACKGROUND

Driver assistance systems are control systems for vehicles that increase the comfort and safety of vehicle occupants. Due to the general tendency to provide occupants with new safety and comfort functions, the complexity of modern vehicles has increased over time, and is expected to increase further in the future. The addition of new driver assistance features adds complexity to the operation of the vehicle. Since these driver assistance systems use light, sound, and active vehicle control, they are necessarily intrusive into the driver's control of the vehicle. Consequently, new driver assistance systems take time for drivers to learn. Drivers sometimes ignore or disable these systems rather than learn to use them.

### SUMMARY

A driver assistance system takes as input a number of different types of vehicle environment inputs including positions of hazards such as a road boundary, lane boundaries, and objects in the vehicle's environment. The driver assistance uses the inputs to determining a lane change risk function based on the lane boundary position, a road boundary risk function based on the road boundary position, and a collision risk function based on the object position. The risk functions quantifying the risk posed to the vehicle by the detected hazards. Based on the risk functions, the driver assistance controls an actuator of the vehicle. This may include control of actuators such as the steering wheel, brake system, and gas, as well as audio and visual display and warning systems.

In one embodiment, the driver assistance system receives a plurality of vehicle environment inputs including a position of each of a plurality of hazards, the hazards having a lane boundary, a road boundary, and at least one object. The driver assistance system uses the inputs to determine a lane change risk function based on the lane boundary position, the lane change risk function quantifying a risk to the vehicle associated with exiting a lane. The driver assistance system further uses the inputs to determine a road boundary risk function based on the road boundary position, the road boundary risk function quantifying a risk to the vehicle associated with exiting a road. The driver assistance system further uses the inputs to determine a collision risk function based on the object position, the collision risk function quantifying a risk to the vehicle associated with collision with the object. The driver assistance system uses the determined risk functions to control an actuator of the vehicle based on the lane change risk function, the road boundary risk function, and the collision risk function.

In one specific embodiment, control of the vehicle actuators includes aggregating the lane change risk function, the road boundary risk function, and the collision risk function into an aggregate risk function and generating a graphical representation of the aggregate risk function, the graphical representation illustrating aggregate risk as a function of position in the vehicle environment. The driver assistance system then displays the graphical representation using a display directly or wirelessly coupled to the vehicle.

In another specific embodiment, control of the vehicle actuators includes generating a weighting matrix based on the lane change risk function, the road boundary risk function, and the collision risk function. The driver assistance system actively controls the motion of the vehicle using the weighting matrix, for example by adjusting the braking system, gas pedal/throttle system, and the steering wheel position.

The features and advantages described in the specification are not all inclusive and, in particular, many additional features and advantages will be apparent to one of ordinary skill in the art in view of the drawings and specification. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates an exemplary vehicle environment, according to one embodiment.

FIG. 2 is a block diagram illustrating exemplary components of a vehicle with respect to a driver assistance system, according to one embodiment.

FIG. 3 is an exemplary flowchart for assisting a driver, according to one embodiment.

FIG. 4 is an exemplary illustration of a vehicle environment overlaid with an aggregate risk posed by the vehicle environment to a vehicle along a horizontal x axis as determined by a driver assistance system according to one embodiment.

FIG. 5A is an exemplary graphical representation of aggregate risk posed by the vehicle environment to a vehicle as determined by the driver assistance system according to one embodiment.

FIG. 5B is another exemplary graphical representation of aggregate risk posed by the vehicle environment to a vehicle as determined by the driver assistance system according to one embodiment.

FIG. 6A is another exemplary graphical representation of aggregate risk posed by the vehicle environment to a vehicle as determined by the driver assistance system according to one embodiment.

FIG. 6B is another exemplary graphical representation of aggregate risk posed by the vehicle environment to a vehicle as determined by the driver assistance system according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

### Driver Assistance System Overview

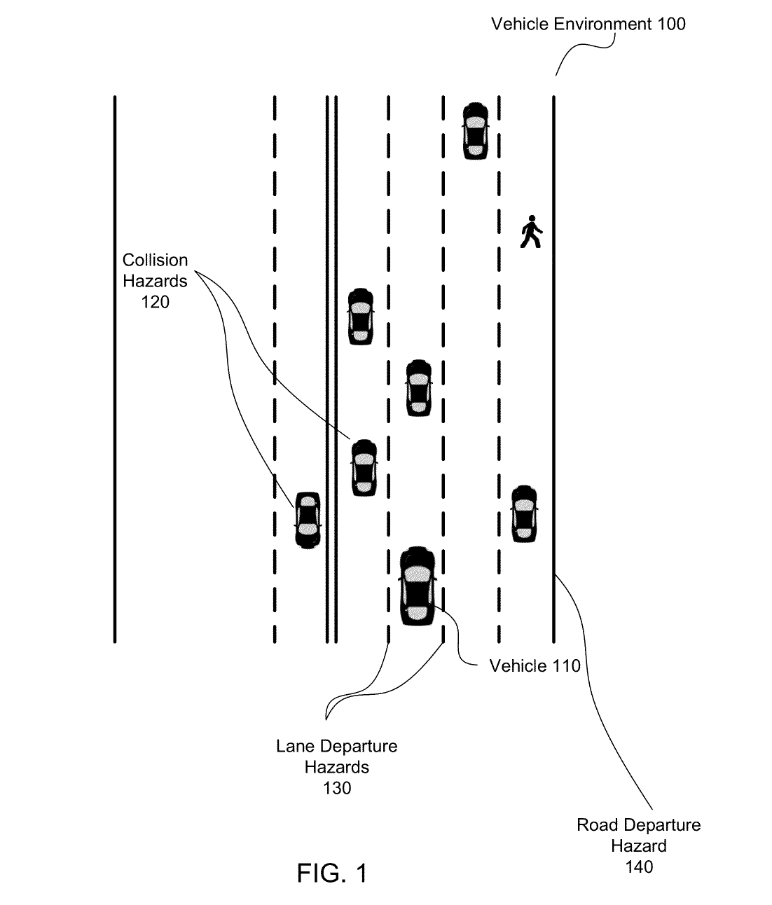

FIG. 1 illustrates an exemplary vehicle environment 100, according to one embodiment. A driver assistance system assists the driver of the vehicle 110 in navigating the environment 100 to avoid detected hazards. Examples of hazards include lane boundary departures 130, road boundary departures 140, and collisions 120 with objects in the vehicle's environment 100. Examples of objects 120 sought to be avoided include anything that can be present in the driver's path, for example, other vehicles, including cars, bicycles, motorcycles, trucks, etc., pedestrians, animals trees, bushes, plantings, landscaping, road signs, and stoplights. This list is intended to be exemplary, and is not considered to be comprehensive. Generally, the driver assistance system is capable of assisting the driver of a vehicle 110 in avoiding any physical object.

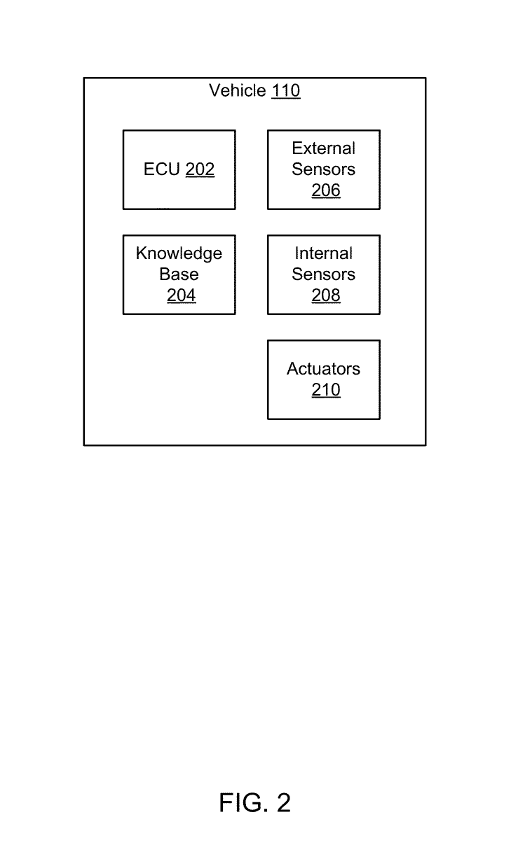

FIG. 2 is a block diagram illustrating exemplary components of the vehicle 110 with respect to a driver assistance system, according to one embodiment. The vehicle includes one or more electronic control units (ECUs) 202, a knowledge base 204 including a set of computer program instructions for a driver assistance system, external 206 and internal 208 sensors for collecting vehicle environment inputs for the driver assistance system, and actuators 210 for controlling the vehicle based on the output of the driver assistance system.

The sensors 206 and 208 collect input data regarding the environment surrounding the vehicle 110. External sensors 206 include, for example, radio detecting and ranging (RADAR) sensors for detecting the positions of nearby objects 120. Light detecting and ranging (LIDAR) may also be used in external sensors 206 in addition to or in place of RADAR. Both RADAR and LIDAR are capable of determining the position (in two dimensions, e.g., the X and Y directions) as well as the distance between a sensed object 120 and the vehicle 110. Although RADAR and LIDAR are provided as examples, other types of sensors may also be used to detect the positions of nearby objects.

RADAR, either alone or in combination with ECU 202 and knowledge base 204, can also provide semantic input information related to an object 120. For example, RADAR may identify an object position as well as a position of lane boundary markers. These inputs may be processed to provide as an input the lane in which a particular object 120 is located. RADAR may also provide information regarding the shape (e.g., physical extent, distance between different parts of the same mass) of an object 120. Consequently, the shape information may be correlated with information stored in the knowledge base 204 to identify the type of object 120 is being sensed (e.g., pedestrian, vehicle, tree, bicycle, large truck, small truck etc.).

External sensors 206 may also include external cameras operating in the visible or IR spectrums. External cameras may be used to determine the same or additional information provided by RADAR, alone or in conjunction with the ECU 202 and knowledge base 204.

External sensors 206 may also include a global positioning system (GPS) capable of determining and/or receiving the vehicle's position on the earth (i.e., its geographical position). External sensors 206 may include devices other than a GPS capable of determining this information, for example, the vehicle 110 may be connected to a data or voice network capable of reporting the vehicle's geographical position to an appropriately configured sensor 206. For example, a portable phone attached to a wireless network may provide geographical position information.

Based on the vehicle's 110 geographical position, one or more communications devices may be used to obtain information relevant to (i.e., local or proximate to the vehicle's position) including traffic information, road maps, local weather information, vehicle to vehicle communications, or other information that is related to otherwise impacts driving conditions. For example, ECU 202 may include or be coupled to a wireless communication device that is wirelessly communicatively coupled to an external voice or data network that may be used to download this information from a remote computing network located externally to the vehicle 110.

Internal sensors 208 include velocity, acceleration, yaw, tilt, mass, force, and other physical quantity sensors that detect the properties and movement of the vehicle 110 itself. In combination, internal sensors 208 and external sensors 206 allow the ECU 202 to distinguish between changes to the vehicle versus changes in the vehicle environment 100. For example, the velocity and/or acceleration of an object 120 moving towards the vehicle 110 can be distinguished and separated from the velocity and/or acceleration of the vehicle 110 towards the object 120.

Internal sensors 208 also include driver awareness sensors that detect whether the driver is paying attention and/or what the driver is paying attention to. These internal sensors 208 may include, for example, an eye gaze sensor for detecting a direction of eye gaze and a drowsiness system for determining whether a driver is drowsy or sleeping (e.g., using a camera). Internal sensors 208 may also include weight or seatbelt sensors to detect the presence of the driver and passengers.

The ECU 202 receives inputs from the external 206 and internal sensors 208 for use with the driver assistance system in knowledge base 204. The ECU processes the received inputs in real time according the driver assistance system to assist the driver in avoiding hazards. Assistance may include both active assistance, for example active control of the gas, brake, and steering wheel, as well as passive assistance provided through the vehicle's 110 audio and visual systems.

Vehicle actuators 210 include, for example, the vehicle's throttle, gas pedal, brakes, gearshift, steering, airbags, seatbelt pre-tensioners, side impact warning system, situation aware lane departure warning system, lane keeping warning system, entertainment system (both visual and audio), a visual and/or audio display of the numerical risks posed by hazards, and any haptic feedback mechanisms installed into actuators such as the steering wheel, brake pedal and gas pedal.

In one implementation, the sensors 206 and 208, ECU, knowledge base 204 and actuators are configured to communicate using a bus system, for example using the controller area network (CAN). In one implementation, the ECU 202 includes a plurality of ECUs rather than being unified into a single ECU. The CAN bus allows for exchange of data between the connected ECUs. In one implementation, the knowledge base 204 is stored in non-transitory computer readable storage medium. The ECU 202 includes a processor configured to operate on received inputs and on data accessed from the knowledge base 204.

### Driver Assistance System

The driver assistance system is configured to control the actuators of the vehicles based on detected hazards. The following sections describe how the risks posed by different types of hazards are quantified and provided to the driver assistance system to control actuator activation. The action taken by the driver assistance system may vary by implementation, may occur automatically, or may be responsive to the driver's elected choice.

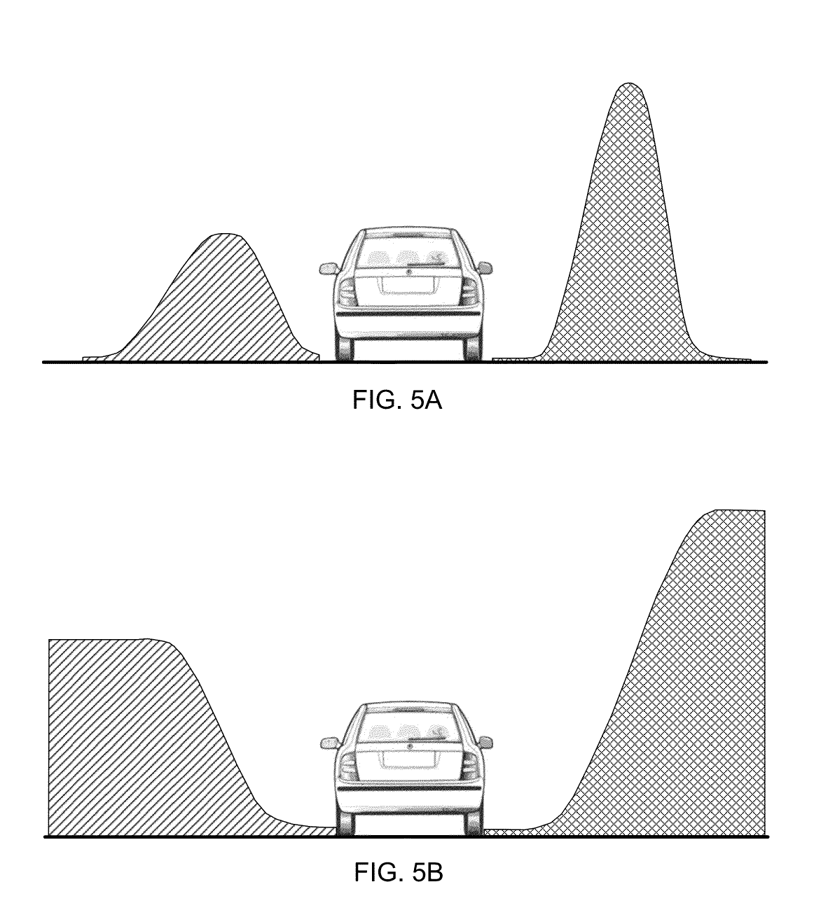

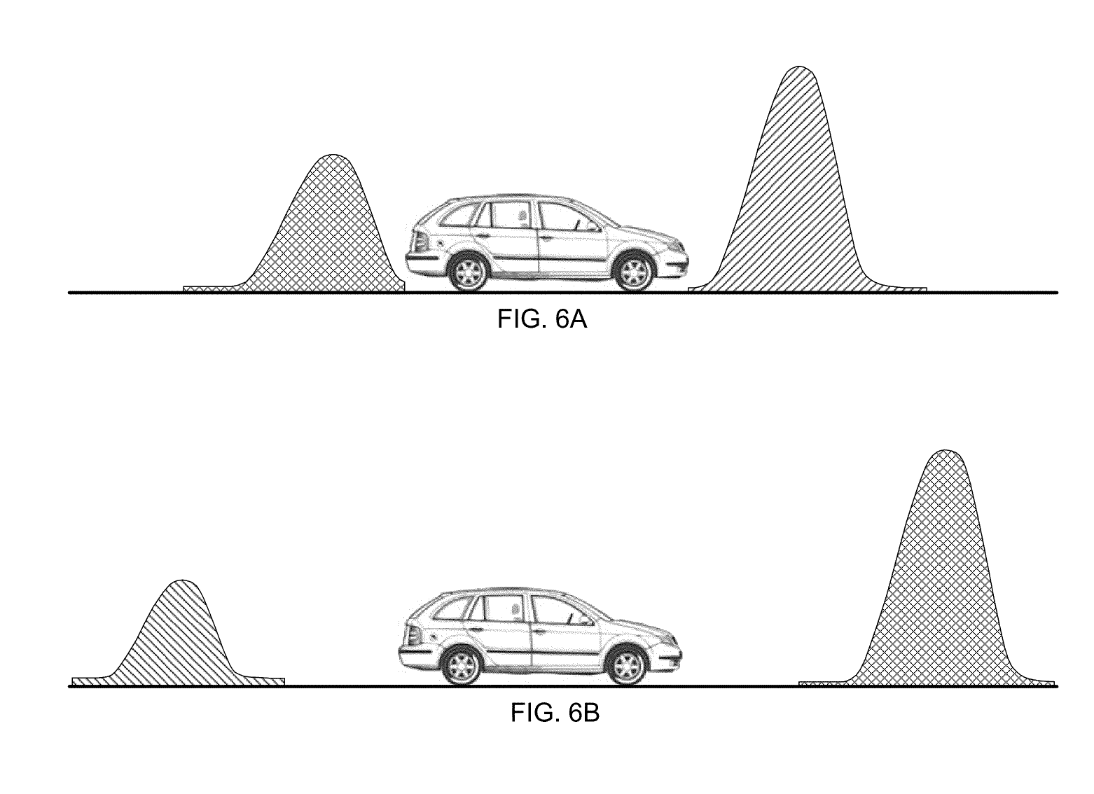

In one implementation, information about detected hazards is fed to the actuators controlling one or more of the vehicle's audio, display, and haptic components to provide visual, auditory, and tactile (force) feedback regarding a quantified amount of risk posed by the detected hazards. For example, the risks posed by various hazards may be aggregated together by the driver assistance system into a graphical representation of risk as a function of position, and provided for display within the vehicle. FIGS. 5A, 5B, 6A, and 6B illustrate exemplary graphical representations of risk for display in an in-vehicle display, such as a heads up display (HUD), an in-dash or center console display, or a smart phone display or other device that is communicatively (e.g., wirelessly) coupled to the vehicle. Examples of haptic feedback include tactile feedback provided through the vehicle's steering wheel, brake pedal, and gas pedal.

In the same or a different implementation, the vehicle's actuators are controlled to cause the vehicle to automatically change velocity to avoid detected hazards and/or move towards a provided destination position without requiring additional actuator action input from the driver. This is accomplished by automatically controlling one or more of the braking system, throttle, steering wheel, transmission, airbags, seat belt tensioners, electrical system, etc. to achieve a path of motion that achieves those goals.

For example, if the driver assistance system is attempting to maintain the vehicle in a same lane, the driver assistance system may turn the steering wheel in a direction to avoid the lane change, and may also make turning the steering wheel towards that lane comparatively more difficult than normal, to signify that the driver should not enter that lane unintentionally. As another example, if the vehicle is rapidly approaching another vehicle directly in front, the driver assistance system may automatically apply the brake and alter the position of the brake pedal to signify that braking is occurring. In this example, the driver assistance system may further make the gas pedal comparatively more difficult than normal for the driver to press, to signify that the driver should not apply any more gas in order to avoid collision.

The driver assistance system operates in conjunction with the driver controlling the vehicle, and as a result the actuators to of vehicle are within the control of both the driver and the driver assistance system. Through manual operation of the vehicle's actuators, the driver is able to override any actuator control operation that is being performed by the driver assistance system. Using the lane departure example above, despite the fact that the driver assistance system may be attempting to avoid entering the next lane by the turning the steering wheel away from that lane, the driver may apply a torque to the steering wheel to override the driver assistance system. The amount of force to override actuator control by the driver assistance system may vary by implementation, as well as based on the numerical risk posed by the hazard as determined by the driver assistance system as described below.

The driver assistance system determines the vehicle's physical dynamics. In one embodiment, the vehicle's physical dynamics are determined according to:

M\ddot{q}=f(\dot{q})+g(u_{c}) (1)

where \dot{q}=[vₓ, v_{y}, ω]^{T} describes the vehicle's longitudinal, lateral, and rotational velocity (vₓ, v_{y}, ω) as provided by the inputs, M is the mass matrix, u_{c} describes the control vector, and f(\dot{q}) describes terms which are not controlled.

The control exerted by the driver assistance system on the vehicle can be expressed in terms of a global (e.g., road fixed) coordinate system. Assuming, for sake of example, a straight road, p=[s, l, φ] describe the distance down the road from the vehicle, the lateral offset from the center lane, and the heading error, respectively. The driver assistance system transforms between the vehicle's position q and the road's position p according to:

\dot{q}=E\dot{p} (2)

where:

$$E = {( \frac{\partial p}{\partial q} )}^{- 1} \qquad ( 3 )$$

and where:

$$\frac{\partial p}{\partial q} = [ \begin{matrix}cos ( ϕ ) & - sin ( ϕ ) & 0 \\ sin ( ϕ ) & cos ( ϕ ) & 0 \\ 0 & 0 & 1\end{matrix} ] \qquad ( 4 )$$

In one embodiment, to constrain the vehicle motion away from hazards, the driver assistance system actively controls the actuators of the vehicle using a motion control strategy of:

\dot{q}=W⁻¹E(\dot{p}_{d}+Ke) (5)

where p_{d} is the vehicle's destination position, \dot{p}_{d}=[v_{xd}, V_{yd}, ω_{d}]^{T} is the destination longitudinal, lateral, and rotational velocity that the motion control strategy is using to arrive at p_{d} in that instant in time. \dot{p}_{d}, e is the error vector between current and destination positions and velocities of the vehicle, and K is a 3 by 3 diagonal positive definite feedback gain matrix.

W is a positive definite hazard weight (or weighting) matrix that provides another set of constraints on the motion of the vehicle in addition to the vehicle's destination position (and associated velocity). The weight matrix W has elements that are based on the numerical risk associated with detected hazards as described below. Generally, the hazard weight matrix W slows and/or stops vehicle motion towards detected hazards, where the amount of the slowing/stoppage is based on the numerical risk posed by the hazard.

In one embodiment, the hazard weight matrix is formed using detected road departure hazards, the lane departure hazards, and collision hazards according to:

W=(W_{RD}+W_{LD}+W_{COL})/v (6)

where W_{RD}, W_{LD}, and W_{COL} represent separate weight matrices associated with road departure hazards, lane departure hazards, and collision hazards, respectively, and where v is a normalization factor.

### Hazards and Risk Determination

Road Departure Hazard

The driver assistance system detects and accounts for road departure hazards, that is the potential hazards posed to the vehicle by leaving the roadway. In quantifying a road departure hazard, the driver assistance system assumes that the driver will generally want to remain on the roadway in most circumstances. While leaving the roadway is not necessarily dangerous, many different possible hazards are located outside the roadway including, for example, objects such as trees, buildings, post office boxes, debris, etc., and un-navigable terrain that may be damaging to the vehicle, including unpaved ground, grass, etc. Thus, absent driver control to the contrary, the driver assistance system determines an amount of risk associated with leaving the roadway based on the possibility of such hazards existing outside the roadway.

To quantify road departure risk the driver assistance system assigns some numerical amount of risk to positions near the road boundary. The amount of risk assigned to the road may be further based on the distance between the vehicle and the boundary, however this is not necessarily the case in all implementations. The driver assistance system may also assign separate/additional risk to actual objects and terrain located outside the road boundary, independent of any risk/hazard assigned to the road boundary. Determination of these separate/additional risks is covered in the section regarding collision hazards described further below.

In one implementation, the driver assistance system determines the numerical risk associated with a road boundary hazard using a road boundary risk function R(q) that depends on the distance between a possible vehicle position q and the road boundary. In one embodiment, R(qₓ q_{y}) is calculated in two dimensions according to:

$$\frac{\partial p}{\partial q} = [ \begin{matrix}cos ( ϕ ) & - sin ( ϕ ) & 0 \\ sin ( ϕ ) & cos ( ϕ ) & 0 \\ 0 & 0 & 1\end{matrix} ] \qquad ( 4 )$$

where B^{L} and B^{R} are the left and right road boundaries along the x and y axes, and where C₁ and C₂ are normalization constants. The road boundary risk R(q) increases asymptotically as the position q approaches the road boundary, and is at a minimum directly between the two road boundaries. This example function is simplified, and in other embodiments the road boundary risk may reach a maximum value rather than approaching infinity. Further, the left and right road boundaries B^{L} and B^{R} may be defined to include only the portion of the road allotted for traveling in a particular direction. Further, the example above may include offsets to allow the vehicle to occupy any space on the road (e.g., any lane) without the road boundary risk increasing significantly. Further, the above example uses left and right of the vehicle, however, in practice the vehicle may approach from any direction, and R(q) may be calculated accordingly.

The driver assistance system may further determine the gradient of the road boundary risk function ∇R, indicating the direction of fastest rate of increase of R. Using the example above, the gradient of the road boundary function ∇R is determined according to:

$$∇ R = \frac{\partial R}{\partial q} = [ \frac{\partial {R}_{x}}{\partial {q}_{x}} , \frac{\partial {R}_{y}}{\partial {q}_{y}} ] \qquad ( 8 )$$

such that:

$$\frac{\partial {R}_{i}}{\partial {q}_{i}} = \frac{{( {B}_{i}^{L} - {B}_{i}^{R} )}^{2} ( 2 {q}_{i} - {B}_{i}^{L} - {B}_{i}^{R} )}{4 {( {B}_{i}^{L} - {q}_{i} )}^{2} {( {q}_{i} - {B}_{i}^{R} )}^{2}} \qquad ( 9 )$$

where i equal x or y. The gradient of the risk boundary function is equal to zero if the vehicle is at the center of the range, and goes to infinity at the left and right boundaries.

The driver assistance system uses the gradient of the road boundary function FR to determine a road departure weight matrix W_{RD}. The road departure weight matrix is a 2×2 diagonal matrix with diagonal elements wₓ^{RD} and w_{y}^{D} (generally wᵢ^{RD}), defined by:

$${w}_{i}^{RD} = \{ \begin{matrix}1 + \vert \frac{\partial {R}_{i}}{\partial {q}_{i}} \vert & if Δ \vert \frac{\partial {R}_{i}}{\partial {q}_{i}} \vert \geq 0 , \\ 1 & if Δ \vert \frac{\partial {R}_{i}}{\partial {q}_{i}} \vert < 0.\end{matrix} \qquad ( 10 )$$

where the term

$$Δ \vert \frac{\partial {R}_{i}}{\partial {q}_{i}} \vert$$

represents the change in the magnitude of the gradient function. A positive value indicates the vehicle is moving toward the road boundary, while a negative value indicates the vehicle is moving away from the road boundary.

When the vehicle moves toward the road boundary, the associated weighting factor wᵢ^{RD} becomes larger the closer to the road boundary, forcing the vehicle to slow down or stop the component of the motion toward the boundary. If the vehicle is moving away from one road boundary, the vehicle's motion toward the boundary is not reduced by that particular road boundary (though it may be affected by another road boundary).

Lane Departure Hazard

The driver assistance system detects and accounts for lane departure hazards. The assumption is that the driver will generally want to remain in a same lane unless turning or deliberately changing lanes. While leaving the current lane is not necessarily dangerous, many different possible hazards are located in other lanes including, for example, objects such as other vehicles, pedestrians, bikers, debris, etc. Owing to the fact that there are many valid instances where the driver will want to change lanes, the amount of risk assigned to the lane boundary is relatively low, particularly compared to road boundary risks and collision risks at similar possible vehicle positions.

To account for lane departure hazards the driver assistance system assigns some numerical amount of risk to positions near the lane boundary. The amount of risk assigned to a possible vehicle position q is based on the distance between the possible vehicle position q and the lane boundary. The risk at position q represents the risk to the vehicle should the vehicle be located at position q. In some embodiments, the risk at position q may also be based on the current position of the vehicle, regardless of whether the vehicle is at position q or not.

In one implementation, the driver assistance system determines the numerical risk associated with lane departure as a lane departure risk function L(q) that depends on the distance between a possible lateral position qₓ of a vehicle and the position of the lane boundary. In one embodiment, L(qₓ) is calculated according to:

$$L ( q ) = {C}_{3} {e}^{- \frac{( {q}_{x} - {L}^{L} )}{2 {σ}^{2}}} + {C}_{4} {e}^{- \frac{( {q}_{x} - {L}^{R} )}{2 {σ}^{2}}} \qquad ( 11 )$$

where L^{L} and L^{R} are the right and left lateral positions of the lane boundary, δ shapes the full width half maximum of the lane risk function L(qₓ), and C₃ and C₄ are normalization constants. The lane risk function L(qₓ) increases to a maximum value at the lane boundary, and drops to zero away from the lane boundary. In another embodiment, L(q) may also include an additional term for the position q_{y} of the vehicle along the y axis with respect to the lane boundary.

The driver assistance system may further determine the gradient of the lane boundary risk function [symbol] L, indicating the direction of fastest rate of increase of L. Using the example above, the gradient of the lane boundary function [symbol] L is determined according to:

$$∇ L = \frac{\partial {L}_{x}}{\partial {q}_{x}} \qquad ( 12 )$$

such that:

$$\frac{\partial {L}_{x}}{\partial {q}_{x}} = - \frac{{C}_{3}}{2 {σ}^{2}} {e}^{- \frac{( {q}_{x} - {L}^{L} )}{2 {σ}^{2}}} - \frac{{C}_{4}}{2 {σ}^{2}} {e}^{- \frac{( {q}_{x} - {L}^{R} )}{2 {σ}^{2}}} \qquad ( 13 )$$

The gradient of the lane boundary function [symbol] L is near zero away from a lane boundary, and increases in value the greater the vehicle's velocity toward a lane boundary.

The driver assistance system uses the gradient of the lane boundary function [symbol] L to determine a lane departure weight matrix W_{LD}. The lane departure weight matrix is a 2×2 diagonal matrix with one diagonal element wₓ^{LD} in the upper left corner element, defined by:

$${w}_{x}^{LD} = \{ \begin{matrix}1 + \vert \frac{\partial {L}_{x}}{\partial {q}_{x}} \vert & if Δ \vert \frac{\partial {L}_{x}}{\partial {q}_{x}} \vert \geq 0 , \\ 1 & if Δ \vert \frac{\partial {L}_{x}}{\partial {q}_{x}} \vert < 0.\end{matrix} \qquad ( 14 )$$

where the term

$$Δ \vert \frac{\partial {L}_{x}}{\partial {q}_{x}} \vert$$

represents the change in the magnitude of the gradient function. A positive value indicates the vehicle is moving toward the lane boundary, while a negative value indicates the vehicle is moving away from the lane boundary.

When the vehicle moves toward the lane boundary, the weighting factor wₓ^{LD} becomes larger closer to the lane boundary, forcing the vehicle to slow down or stop. If the vehicle is moving away from the lane boundary, the vehicle's motion is not affected by the lane boundary (thought it may be affected by another lane boundary).

Collision Hazards

The driver assistance system detects and accounts for the collisions hazards. The assumption is that the driver will generally want to avoid collisions with objects in the vehicle's environment, examples of which include other vehicles, pedestrians, bikers, debris, etc.

To account for collision hazards the driver assistance system assigns a numerical amount of risk to possible vehicle positions q near objects in the vehicle's environment. The amount of risk assigned is based on the distance between the possible vehicle position q and object. Generally, collision hazards are assigned a higher numerical value than road or lane departure hazards, all else being equal. This is because collision risks are based on actual detected objects (based on received inputs), whereas road and lane departure hazards are based on assumptions by the driver assistance system about possible harm that may or may not occur if the vehicle leaves the lane or road. Were a collision with an object to occur at any speed, damage or harm to vehicle and its passengers will very likely result. Most often, preventing the collision is paramount, and so assigning a comparatively high numerical risk is one way for the driver assistance system to help achieve this outcome.

In one implementation, the driver assistance system determines the numerical risk associated with a collision with an object using a collision risk function C(q) based on a distance between a potential vehicle position q and the object. C(q) has a maximum value at q equals 0, and decays as q increases. As an example, C(q) may be determined according to:

C(q)=C₅e^{-αq}^{_{q}}^{-β} (15)

where C₅ is a normalization constant, and α and β control the rate of decay.

The driver assistance system may further determine the gradient of the collision function [symbol] C, indicating the direction of fastest rate of increase of C(q). Using the example above, the gradient of the collision function [symbol] C is determined according to:

$$∇ C = \frac{\partial C}{\partial q} = [ \frac{\partial {C}_{x}}{\partial {q}_{x}} , \frac{\partial {C}_{y}}{\partial {q}_{y}} ] \qquad ( 16 )$$

such that:

$$\frac{\partial C}{\partial {q}_{i}} = - {C}_{5} {e}^{- {α}_{i} {q}_{i}} {q}_{i}^{- β} ( β {q}_{i}^{- 1} + α ) \qquad ( 17 )$$

where i equal x or y.

The driver assistance system uses the gradient of the collision function ∇C to determine a collision weight matrix W_{COL}. The collision weight matrix is a 2×2 diagonal matrix with diagonal elements wₓ^{COL} and w_{y}^{COL} (generally wᵢ^{COL}), defined by:

$${w}_{i}^{COL} = \{ \begin{matrix}1 + \vert \frac{\partial {C}_{i}}{\partial {q}_{i}} \vert & if Δ \vert \frac{\partial {C}_{i}}{\partial {q}_{i}} \vert \geq 0 , \\ 1 & if Δ \vert \frac{\partial {C}_{i}}{\partial {q}_{i}} \vert < 0.\end{matrix} \qquad ( 18 )$$

where the term

$$Δ \vert \frac{\partial {C}_{i}}{\partial {q}_{i}} \vert$$

represents the change in the magnitude of the gradient function. A positive value for this term indicates the vehicle motion is causing the vehicle to move closer to collision with the object. Consequently, the weighting factor wᵢ^{COL} becomes large, causing the motion of the vehicle to slow or stop. A negative value for this term indicates that the vehicle's motion is causing the vehicle to move further away from a collision. Consequently, the weighting factor wᵢ^{COL} remains low, thereby not impeding the motion of the vehicle.

Generally, there may be more than one object in the vehicle's environment at any given time. The driver assistance system determines a separate weighting factor wⱼ^{COL} for each object. The collision gradient weighting matrix W_{COL} including weighting factors for all objects for which the risk of collision is above a threshold is given by:

$${w}_{COL} = {\sum }_{j}^{{N}_{c}} [ \begin{matrix}{w}_{x , j}^{COL} & 0 \\ 0 & {w}_{y , j}^{COL}\end{matrix} ] \qquad ( 19 )$$

where there are a total number of objects N_{c}. Generally, additional objects will increase the weighting factor along each axis.

Destination Guide

As introduced above, the driver assistance system may be provided destination information about where the driver wants the vehicle to go. In one embodiment, the driver assistance system uses the destination information to generate a destination function D(q) that is similar to a risk function, except that it represents a position the driver assistance system wants the vehicle wants to reach, rather than a position the driver assistance system wants to avoid.

The destination function D(q) that depends on the distance between a possible vehicle position q and the destination position. D(q) represents whether position q is assisting or hurting the vehicle's goal to reaching the destination position. D(q) has a maximum value where q achieves or helps achieve the destination position, and has a minimum away from such positions.

In an embodiment different from the one described above with respect to equation (5), the destination function is used by the driver assistance system in conjunction with the risk functions to assist the vehicle in reaching a destination position. For example, the destination function D(q) the destination function acts as a “negative” risk, reducing the risk values associated with a position and/or direction that causes the vehicle to travel towards its destination. In one embodiment, the destination information includes not only the actual destination position, but also road and lane information, so that the destination information includes routing information for reaching the destination while also remaining within established lanes and roadways.

In the same or a different embodiment, the destination function and risk functions are combined and displayed to the driver. Display of destination and risk functions is described further below.

Adjusting Risk Values

Numerical risks associated with detected hazards may be adjusted based on inputs received by the vehicle which are not directly tied to individual hazard types or objects 120, but which nevertheless affect the risks posed to the vehicle. The driver assistance system adjusts numerical risks using at least two different categories of inputs: local inputs and global inputs.

Local inputs are inputs that affect individual hazards differently. For example, a direction of a driver's attention such as a head direction input or an eye gaze direction input may have been received from an internal sensor 208 indicating that the driver's is looking to the left at that instant in time. Consequently, the ECU 202 may alter the numerical risks associated with hazards on the vehicle's right side to be higher than they would be otherwise, due to the driver's lack of attention on that area. Similarly, the ECU 202 may alter the numerical risks for hazards on the left of the vehicle to be lower than they would be otherwise, in this case due to the driver's known attention to that area.

Numerical risks may also be adjusted based on global inputs that are applied to all hazards equally. Altering numerical risks equally is based on the assumption that some inputs are expected to either negatively affect a driver's ability to react to any hazard in the vehicle environment 110, and/or negatively affect a driver's ability to mitigate the harm caused by those hazards. Examples of global inputs include, for example, weather, road conditions, time of day, driver drowsiness, seat belt warnings, and the weight on each passenger seat. More specifically, poor weather conditions (e.g., rain, fog, snow), hazardous road condition (e.g., wet roads, snow covered roads, debris on the roadway, curvy roadway), nighttime or dusk, indications that the driver is drowsy, and indications that one or more seatbelts are unbuckled while the weight on those seats indicates a person is seated are all examples of global inputs that increase the risk posed by hazards. Conversely, favorable weather and road conditions (e.g., dry, straight roads), daytime, indications that the driver is not drowsy, and indications that all needed seatbelts are strapped in are all examples of global inputs that reduce numerical risks.

Driver cognitive load is another example of a global input. Due to multi-tasking, such as cell phone use, entering information in a vehicle's onboard navigation system, adjusting the thermostat, changing radio stations, etc., the driver may be paying attention to things other than the road. The ECU 202 may receive inputs regarding the driver's cognitive load. For example, eye gaze input and inputs from vehicle electronics may indicate the total time or frequency with which the driver's attention is diverted from the road. The ECU 202 may be configured to convert this into a driver cognitive load input, which may in turn be used as a global input for determining numerical risks of hazards.

As another example, in addition to using gaze direction (or driver head pose) as a local input, gaze direction may also be used to determine the relative attentiveness of the driver to the forward roadway. Driver attentiveness to the forward roadway is a global input. With respect to driver gaze direction, merely glancing away from the road does not necessarily imply a higher risk of accident. In contrast, brief glances by the driver away from the forward roadway for the purpose of scanning the driving environment are safe and actually decrease near-crash/crash risk. However, long glances (e.g., two 2 seconds) increase near-crash/crash risk. In one embodiment, gaze direction is combined with duration of gaze direction to determine the driver attentiveness input. The driver attentiveness input may be described by a modulation factor that is a function of the time duration that the driver is not attentive to the forward roadway based on the gaze direction (or, alternatively, the head-pose direction).

Exemplary Environment and Method

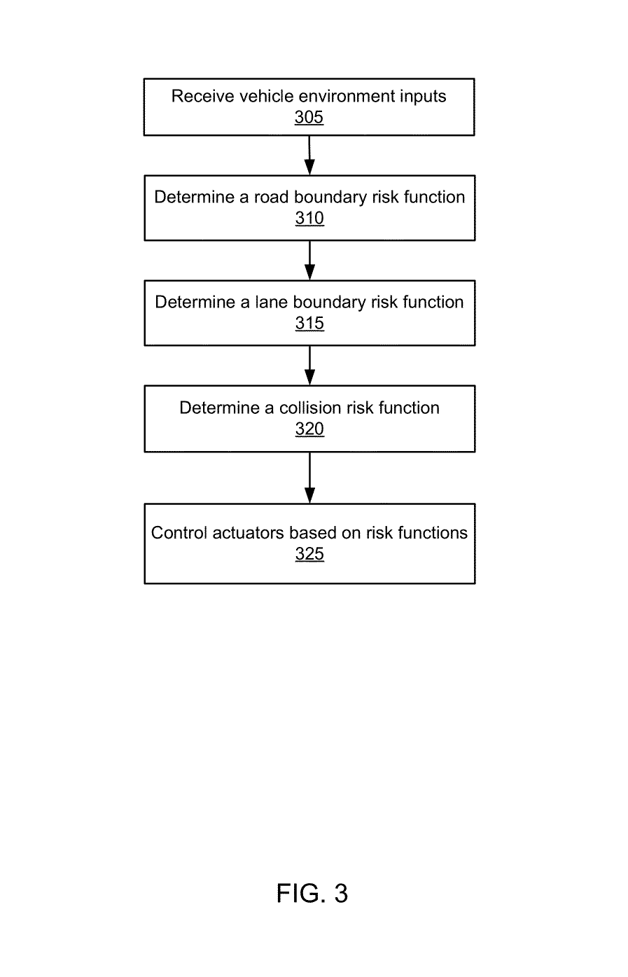

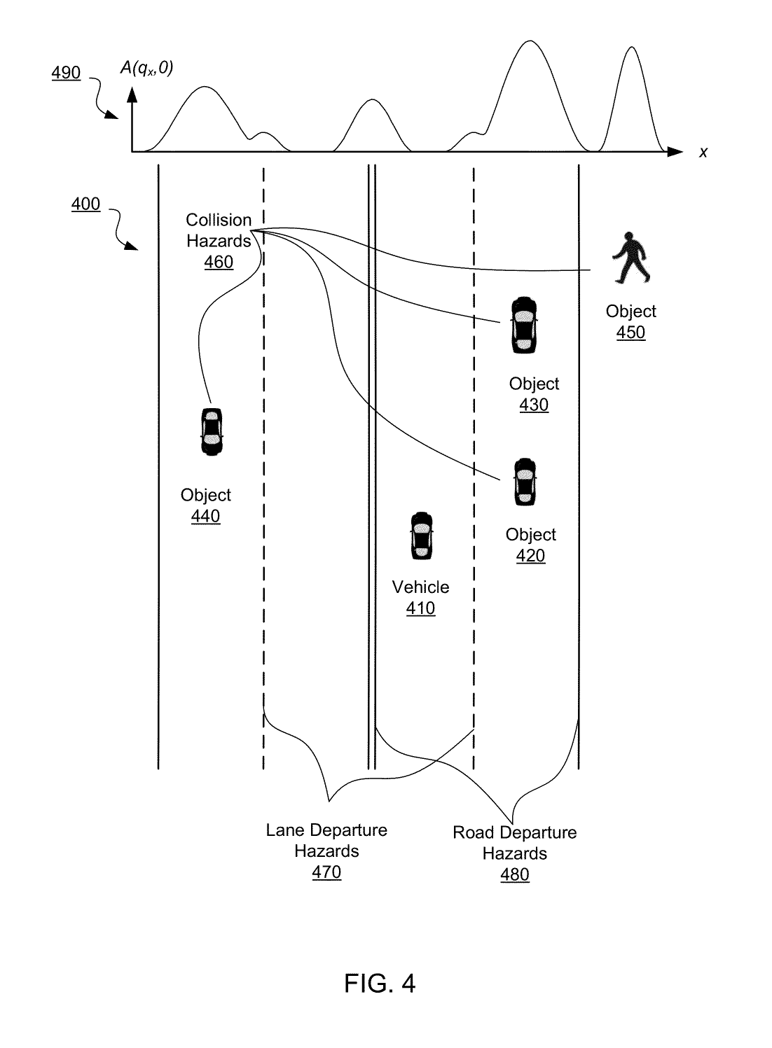

FIG. 3 is an exemplary flowchart for the steps performed by the driver assistance system in assisting the driver, according to one embodiment. These steps are described in relation to the example of FIG. 4 for clarity. FIG. 4 is an exemplary illustration of a vehicle environment 400 overlaid with risk functions according to one embodiment.

During operation of the vehicle 410, the sensors 206 and 208 of the vehicle receive 305 inputs regarding the environment 400 of the vehicle. In this example environment 400, the inputs include information indicating that the vehicle 410 is traveling in a lane of a road, and is surrounded by several objects 420, 430, 440, and 450.

The driver assistance system processes the inputs to determine the risk functions associated with the various hazards in the vehicle environment 410. The risk functions provide a risk value at a number of different possible vehicle positions q in the vehicle's environment 400. Generally, this means that each x, y coordinate position in a Cartesian coordinate system is determined to have a risk value that is the sum of the different risk functions at that position. The risk functions include a road boundary risk function 310, a lane boundary risk function 315, and a collision risk function 320. The driver assistance system may also determine a destination function (not shown). In the example of FIG. 4, the road departure risk function R(q) is determined 310 based on the boundaries of the road, denoted in FIG. 4 as road departure hazards 480. The lane departure risk function L(q) is determined 315 based on the boundaries of one or more lanes, denoted in FIG. 4 as lane departure hazards 470. The collision risk functions C(q) are determined 320 based on the position of each identified object 420-450.

The overlaid risk function A(qₓ, 0) illustrates the aggregated sum of the various risk functions L(qₓ, q_{y}), R(qₓ, q_{y}), C(qₓ, q_{y}) along the x axis assuming a y axis position of zero, that is assuming the y axis of the example risk function A(qₓ, q_{y}) passes through the center of vehicle 410. Each position along the x axis has a separate risk value which is the sum of the road boundary, lane boundary, and collision risk functions at that position. For example, in FIG. 4 A(qₓ, 0) is relatively greater in risk value at values of x where objects 420 and 430 appear compared to where object 440 appears. This difference in risk value may be attributed to the aggregation of risk functions for objects 430 and 420 relative to object 440 alone, assuming for sake of example that the collision risk functions of each of objects 420, 430 and 450 are similar.

Risk functions and risk values at particular positions may also vary due to the type of object, as identified by the inputs. For example, in FIG. 4 the sum of risk functions for objects 420 and 430 is similar in height to the risk function of object 450 alone, with the difference being that object 450 has a risk function that falls off more quickly with change in x axis position. This may indicate, for example, that pedestrians have risk functions with greater average height than other objects (e.g., vehicles). However due to pedestrian's smaller physical size, their risk functions fall off faster as distance increases relative to other objects. Generally, the height and shape of a risk function is determined not only by the type of hazard that led to the risk function, but also based on identified information about the hazard (e.g., type) as provided by the inputs, and in some implementations based on the distance between the vehicle with the driver assistance system and the hazard.

The driver assistance system uses the determined risk functions to control 330 the vehicle's actuators. As described above, this may include active control of the brakes, gas, and steering wheel. It may also include control of the vehicle's audio and visual systems so that the risk may be presented to the driver for their benefit.

Human Machine Interface for Displaying Risk

FIGS. 5A, 5B, 6A, and 6B are exemplary graphical representations of aggregate risk posed by the vehicle environment to a vehicle as determined by the driver assistance system, according to one embodiment. The driver assistance system determines the graphical representation of aggregate risk in order to provide it for display on an in-vehicle display (embedded or remotely coupled). By providing the graphical representation of aggregate risk for display, the driver assistance system is able to provide a compact, easily understood representation of the vehicle environment so that the driver of the vehicle can take action if necessary.

The graphical representation of aggregate risk is one or more plots (or graphs) of aggregate risk function A(qₓ, q_{y}) that is based on the risk functions L(qₓ, q_{y}), R(qₓ, q_{y}), C(qₓ, q_{y}) based on the detected hazards in the vehicle environment. The graphical representation is centered around the vehicle, along a single axis (e.g., along the x axis where y=0 or along y axis where x=0). Higher aggregate risks correspond to higher values in the plot of aggregate risk, and lower values correspond to lower values in the plot of aggregate risk. In one implementation, the height of the plot of aggregate risk at a given position is scaled based on the distance of the hazard from the current position of the vehicle. For example, hazards that are closer to the vehicle are plotted with a first normalization constant, and hazards that are further from the vehicle are plotted with a second normalization constant lower than the first normalization constant.

In one embodiment, the graphical representation includes two portions, one depicting the aggregate risk function on the left side of the vehicle, and another depicting the aggregate risk function on the right side of the vehicle. Examples are depicted in FIGS. 5A and 5B. In the same or a different embodiment, the graphical representation includes two portions, one depicting the aggregate risk function in front of the vehicle, and another depicting the aggregate risk function behind the vehicle. Examples are depicted in FIGS. 6A and 6B.

The graphical representation also includes visually distinguishing characteristics (e.g., different colors) for different aspects of the aggregate risk function. The visually distinguishing characteristics may be based on the aggregate risk value at a particular position (e.g., at peak aggregate risk), the mean or median of the aggregate risk function across a range of positions, the integrated risk (e.g., area under the curve of the aggregate risk function across a range of positions), the distance from the vehicle, or any other formulation. For example, a plot of the aggregate risk function of an object that is in close proximity to the vehicle may have one color, but a similar plot of the same aggregate risk function may have a different color if it is not in close proximity to the vehicle.

In one embodiment, different portions of the graphical representation (e.g., left vs. right or front vs. back) have different visually distinguishing characteristics. For example, as depicted in FIGS. 4A and 4B, aggregate risks on the left of the vehicle share a fill pattern, and aggregate risks on the right of the vehicle share another fill pattern. Similarly, as depicted in FIGS. 5A and 5B, aggregate risks in front of the vehicle share a fill pattern, and aggregate risks behind the vehicle share another fill pattern.

Other visually distinguishing characteristics are also possible. Examples of techniques for visually distinguishing different portion of the graphical representation include color coding (e.g., red equal high aggregate risk, yellow equal medium aggregate risk, green equals low aggregate risk), changing line weights, changing luminosity, and patterning the display (e.g., flashing the risk displayed on and off).

The driver assistance system updates the graphical representations of aggregate risk in real time as inputs are received. Thus, as road, lane, and object hazards approach and recede, the corresponding plots of the aggregate risk function will rise and fall based on the positions of those hazards relative to the vehicle.

In the example of FIG. 5A specifically, the graphical representation of aggregate risk on the vehicle's left is lower than the aggregate risk on the vehicle's right. Consequently, the left and right portions of aggregate risk are visually distinguished with different fill patterns. To a driver, the rapid rise and fall of the plots of aggregate risk as lateral distance from the vehicle increases indicates hazards having a defined width along the x axis, thereby indicating a particular type of hazard. For example, the aggregate risk on the left may be based on a lane change hazard, whereas the risk on the right may be based on a collision hazard such as another vehicle. In contrast, in the example of FIG. 5B, the plots of aggregate risk on the vehicle's left and right become constant at a distance from the vehicle and remain constant to the edge of the graphical representation. To a driver, the constant risk indicates a hazard of a different type, such as a retaining wall or building.

The examples of FIGS. 6A and 6B illustrate graphical representations of aggregate risk in front of and behind the vehicle. In FIGS. 6A and 6B, the plots of aggregate risk depict one object in front of the vehicle and another object behind the vehicle at different distances from the vehicle. In FIG. 6A, the objects are closer to the vehicle, and thus have particular fill patterns. In FIG. 6B, the objects are further from the vehicle, and thus have different fill patterns. Further, in the example of FIGS. 6A and 6B the heights of the plots of aggregate risk are scaled based on distance from the vehicle.

Additional Considerations

Vehicles implementing embodiments of the present description include at least one computational unit, e.g., a processor having storage and/or memory capable of storing computer program instructions that when executed by a processor perform various functions described herein, the processor can be part of an electronic control unit (ECU).

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions could be embodied in software, firmware or hardware, and when embodied in software, could be downloaded to reside on and be operated from different platforms used by a variety of operating systems. An embodiment can also be in a computer program product which can be executed on a computing system.

An embodiment also relates to an apparatus for performing the operations herein. This apparatus may be specially constructed for the purposes, e.g., a specific computer in a vehicle, or it may include a general-purpose computer selectively activated or reconfigured by a computer program stored in the computer, which can also be positioned in a vehicle. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), field programmable gate arrays (FPGAs) or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description above. In addition, an embodiment is not described with reference to any particular programming language. It will be appreciated that a variety of programming languages may be used to implement the teachings as described herein, and any references below to specific languages are provided for disclosure of enablement and best mode.

In addition, the language used in the specification has been principally selected for readability and instructional purposes, and may not have been selected to delineate or circumscribe the inventive subject matter. Accordingly, the disclosure is intended to be illustrative, but not limiting, of the scope of the embodiments.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses without departing from the spirit and scope of the embodiments.

What is claimed is:

1. A computer implemented method comprising:
receiving a plurality of vehicle environment inputs comprising a position of each of a plurality of hazards, the hazards comprising a lane boundary, a road boundary, and at least one object;
determining a lane change risk function based on the lane boundary position, the lane change risk function quantifying a risk to the vehicle associated with exiting a lane;
determining a road boundary risk function based on the road boundary position, the road boundary risk function quantifying a risk to the vehicle associated with exiting a road;
determining a collision risk function based on the object position, the collision risk function quantifying a risk to the vehicle associated with collision with the object; and
controlling an actuator of the vehicle based on the lane change risk function, the road boundary risk function, and the collision risk function.

2. The computer implemented method of claim 1 controlling the actuator of the vehicle comprises:
aggregating the lane change risk function, the road boundary risk function, and the collision risk function into an aggregate risk function;
generating a graphical representation of the aggregate risk function, the graphical representation illustrating aggregate risk as a function of position in the vehicle environment; and
displaying the graphical representation inside the vehicle.

3. The computer implemented method of claim 2 wherein the graphical representation is centered around the vehicle.

4. The computer implemented method of claim 2 wherein at least one of:
the road boundary risk function is further based on a distance between the vehicle and the road boundary position,
the lane boundary risk function is further based on a distance between the vehicle and the lane boundary position, and
the collision risk function is further based on a distance between the vehicle and the object position.

5. The computer implemented method of claim 2 wherein at least two different portions of the graphical representation comprise different visually distinguishing characteristics from each other.

6. The computer implemented method of claim 5 wherein the visually distinguishing characteristics include color.

7. The computer implemented method of claim 5 wherein the visually distinguishing characteristics vary based on a distance between the vehicle and the hazard contributing to that portion of the aggregate risk function.

8. The computer implemented method of claim 5 wherein the visually distinguishing characteristics vary based on a portion of the aggregate risk function contributing to the portion of the graphical representation.

9. The computer implemented method of claim 5 wherein the graphical representation is a one-dimensional representation of the aggregate risk function at positions in front of and behind the vehicle.

10. The computer implemented method of claim 5 wherein the graphical representation is a one-dimensional representation of the aggregate risk function at positions on a left side and on a right side of the vehicle.

11. The computer implemented method of claim 1 wherein controlling the actuator of the vehicle comprises:
generating a weighting matrix based on the lane change risk function, the road boundary risk function, and the collision risk function; and
controlling the actuator of the vehicle based on the weighting matrix.

12. The computer implemented method of claim 11 wherein the elements of the weighting matrix are based on gradients of the lane boundary, road boundary, and collision risk functions.

13. The computer implemented method of claim 11 wherein the elements of the weighting matrix are based on distances between the vehicle and the hazards.

14. The computer implemented method of claim 11 wherein controlling the actuator of the vehicle based on weighting matrix comprises at least one of:
slowing motion of the vehicle towards one of the hazards; and
acceleration motion of the vehicle away from one of the hazards.

15. The computer implemented method of claim 11 wherein the weighting matrix is further based on a destination function that is based on a destination position.

16. The computer implemented method of claim 15 wherein controlling the actuator of the vehicle based on weighting matrix including the destination function comprises at least one of:
accelerating the vehicle towards the destination position; and
slowing motion of the vehicle away from the destination position.

17. A non-transitory computer readable storage medium including instructions that, when executed by a processor, cause the processor to:
receive a plurality of vehicle environment inputs comprising a position of each of a plurality of hazards, the hazards comprising a lane boundary, a road boundary, and at least one object;
determine a lane change risk function based on the lane boundary position, the lane change risk function quantifying a risk to the vehicle associated with exiting a lane;
determine a road boundary risk function based on the road boundary position, the road boundary risk function quantifying a risk to the vehicle associated with exiting a road;
determine a collision risk function based on the object position, the collision risk function quantifying a risk to the vehicle associated with collision with the object; and
control an actuator of the vehicle based on the lane change risk function, the road boundary risk function, and the collision risk function.

18. The non-transitory computer readable storage medium of claim 17 wherein controlling the actuator of the vehicle comprises:
aggregating the lane change risk function, the road boundary risk function, and the collision risk function into an aggregate risk function;
generating a graphical representation of the aggregate risk function, the graphical representation illustrating aggregate risk as a function of position in the vehicle environment; and
displaying the graphical representation inside the vehicle.

19. The non-transitory computer readable storage medium of claim 18 wherein at least two different portions of the graphical representation comprise different visually distinguishing characteristics from each other.

20. The non-transitory computer readable storage medium of claim 17 wherein controlling the actuator of the vehicle comprises:
generating a weighting matrix based on the lane change risk function, the road boundary risk function, and the collision risk function; and
controlling the actuator of the vehicle based on the weighting matrix.
